(19) United States
(12) Patent Application Publication
(10) Pub. No.: US 2008/0102320 A1
(43) Pub. Date: May 1, 2008

(54) NON-ERASABLE MAGNETIC IDENTIFICATION MEDIA

(76) Inventors: Alan S. Edelstein, Alexandria, VA (US); Greg A. Fischer, Jessup, MD (US)

Correspondence Address: U S ARMY RESEARCH LABORATORY;ATTN AMSRL CS CC IP, 2800 POWDER MILL RD, ADELPHI, MD, 207831197, US

(21) Appl. No.: 11/970,072

(22) Filed: Jan. 7, 2008

Related U.S. Application Data
(63) Continuation-in-part of application No. 10/824,396, filed on Apr. 15, 2004.

(51) Int. Cl. G11B 5/66; G11B 5/33; B05D 5/12; F27B 9/12

(52) U.S. Cl. 428/828; 428/800; 427/130; 432/18

(57) ABSTRACT

A magnetic storage medium and method of manufacturing the same comprises a substrate, a magnetic material adjacent to the substrate, and regions of variable magnetic permeability in the magnetic material, wherein the magnetic material may comprise a multilayered structure. Moreover, methods are described for making two kinds of media, read only and read/write media. Additionally, the magnetic material comprises any of permalloy, metallic glass, copper, nickel, iron, cobalt, boron, silicon and any combination thereof, and the magnetic material is approximately 10 to 1,000 nm thick. The regions of variable magnetic permeability comprise regions having a lower permeability than other regions, wherein the regions having a lower permeability than other regions is crystalline, and the regions having a higher permeability can be either crystalline or amorphous, and wherein the areas of lower and higher permeability are dimensioned and configured to be approximately 1 to 20 microns in size.

### CROSS-REFERENCE TO RELATED APPLICATIONS

This is a continuation-in-part application of pending application Ser. No. 10/824,396 filed Apr. 15, 2004.

### STATEMENT OF GOVERNMENT INTEREST

The invention described herein may be manufactured, used, and/or licensed by or for the United States Government.

### BACKGROUND OF THE INVENTION

The present invention generally relates to magnetic storage media, and more particularly to read/rewrite magnetic storage media capable of withstanding deleterious effects due to exposure from a magnetic field.

### DESCRIPTION OF THE RELATED ART

Currently, magnetic information stored on a credit card stripe, debit card stripe, magnetic tape, or hard drive media is stored by maintaining the direction of magnetization in localized areas. Unfortunately, this information is susceptible to being altered or even completely erased if the storage media (credit card stripe, debit card stripe, etc.) is exposed to a magnetic field that is large enough to modify the direction of the magnetization in these localized areas.

Magnetic films are used in a variety of devices that include magnetic random access memories (MRAM) and magnetic recording media. In the constantly evolving magnetic recording industry, information is generally stored as magnetic bits on thin ferromagnetic films. In reading such magnetic bits, detection devices are used to measure the direction and amplitude of the magnetization of small regions along a magnetic track. Computer storage devices, such as magnetic disk drives utilize read/write heads to store and retrieve data. A write head stores data by utilizing magnetic flux to set the direction and amplitude of the magnetic moment of a particular area on a magnetic medium. The state of the magnetic moment is later read by a read head, which senses the magnetic fields.

Conventionally, read heads utilize giant magnetoresistance (GMR) read heads, which are spin valve transistors or other devices similar to spin valves. These GMR thin-film read heads employ a magnetoresistive structure, generally formed in a layered structure of ferromagnetic and non-ferromagnetic metals, to detect the magnetic moments of the data bits on the media. A sensing current is passed through the magnetoresistive material to detect changes in the resistance of the material induced by the data bits as they pass the read head. Spin valve transistors can be formed in different arrangements, but are usually configured as three layer structures including a hard or pinned ferromagnetic layer, a soft ferromagnetic layer, and a thin intervening conductor layer. A general overview of magnetic storage devices and spin valve transistors, including the materials used in constructing these devices is described in U.S. Pat. No. 6,381,171 issued to Inomata et al., the complete disclosure of which is herein incorporated by reference.

Exposure of magnetic storage media to magnetic fields may, however, cause deleterious effects, such as altering or deleting the stored data. Therefore, there remains a need for a novel magnetic storage media device capable of withstanding the harmful effects of large magnetic fields as well as a novel method of manufacturing such magnetic storage media devices.

Another concern in conventional magnetic recording is that it will become very difficult to keep increasing the density of bits per square inch. The most serious factor limiting magnetic recording density is the superparamagnetic limit or superparamagnetic effect (See R. Wood, IEEE Trans. on Magnetics, Vol. 36, No. 1, p. 36 (2000)). To retain information in the form of the direction of the magnetization in a region against thermal fluctuations it is required that KᵤVol/K_{B}T≧35 where Kᵤ is the anisotropy energy, Vol is the volume of the region, K_{B} is the Boltzman constant and T is absolute temperature. When this inequality is no longer satisfied, the region's magnetization will continually change its direction and the region is said to be superparamagnetic.

### SUMMARY OF THE INVENTION

In view of the foregoing, the instant invention is a method for storing and reading data in a magnetic medium in a way that is non-erasable and cannot be changed by exposure to an accidental magnetic field. More particularly, because the magnetic permeability of a material is an intrinsic property, the instant invention is a magnetic information storage technology based on using magnetic permeability to achieve this goal. There are two previous U.S. Pat. Nos. 7,233,142 and 6,762,954, that describe devices for reading the magnetic permeability. Here an embodiment of the invention provides a magnetic storage device or medium comprising a substrate and on the substrate regions of high and low magnetic permeability. The magnetic material may comprise selected areas of a single layer, a bilayer, a multilayer structure, or a two-phase mixture of ferromagnetic nanoparticles embedded in a heat-drawing material having a melting temperature greater than a melting temperature of the ferromagnetic nanoparticles. The new magnetic storage media can either be written to be a read only media or it can be a read/rewrite media.

An example of a read only media comprises a single layer of selected areas covered with a highly permeable magnetic material disposed on a substrate. The substrate may be spin coated with a photoresist and then a light source is used to define patterns prior to depositing magnetic material such as permalloy with high permeability. Thereafter, the unwanted magnetic material could then be lifted off. This methodology of producing patterned media in which information is encoded in well defined regions of high and low permeability rather than dependent upon the magnetization of the regions is unique and well suited for low data density applications such as credit cards, ID cards, and debit cards.

Another example of a read only media is a bilayer or a multilayer of a magnetic material and a nonmagnetic material. The magnetic material may comprise nickel or permalloy and the nonmagnetic material may comprise copper. The magnetic material would have magnetic permeability as large as 10,000. When areas of the media are exposed to heat, such as heat provided by laser pulses, the magnetic layer(s) and the nonmagnetic layer(s) mix together making these areas nonmagnetic and nonpermeable. The regions after mixing would have a magnetic permeability of approximately 1. Thus, the ratio of the permeability of the magnetic regions to the mixed regions would be 10,000 to 1 although a smaller ratio of 1000 to 1 is sufficient to facilitate reading the information. This change is non-reversible. Thus, the permeability of these regions would not be modified by the application (exposure) of a magnetic field, regardless of its strength. Furthermore, the areas that are not exposed to the laser pulse still posses their original magnetic permeability. The thickness of the magnetic material is approximately 10 to 1,000 nm thick. This range of thickness of the magnetic material includes a minimum thickness (10 nm) to provide a significant change in the magnetic flux path for the magnetic reader when the magnetic reader (read head) passes over the magnetic media. In general, thicker films work better than thinner films. The maximum thickness (1,000 nm) is chosen to provide ease and convenience during fabrication. Films much thicker than the maximum thickness (1,000 nm) would inherently be less conventional and more costly, and thus would not be preferable to use. Modifying the permeability of the medium by this process is relatively inexpensive. It would be considerable lower cost, for example, than the ion mixing method of Baglin, U.S. Pat. No. 6,331,364.

An example of a read/rewrite media comprises material that undergoes a phase transition between two phases, one of which has a high magnetic permeability and the other that has a low magnetic permeability. Metglas® is a trademark applied to a class of ferromagnetic amorphous alloys of metal or generically metallic glass and is an example of such a material. More particularly, metallic glass is an alloy composed of a metal and a glass-former such as boron and silicon. In an embodiment of the invention, the metal is ferromagnetic or an alloy of ferromagnetic metals such as iron, cobalt, and nickel. Amorphous ferromagnets with appropriate compositions have high magnetic permeabilities, of order 5000. In most cases, when these materials are crystallized, they have a lower magnetic permeability. Metglas or metallic glass used in magnetic applications has a magnetic permeability of several thousand. When Metglas is crystallized it has a much lower magnetic permeability, several hundred, than when it was amorphous. The phase that the material is in may be controlled by the cooling rate after heating to a specific temperature. Moreover, a laser pulse with an appropriate amplitude and pulse shape may control the temperature and cooling rate. Thus, exposing specific areas to a laser pulse could make these areas either crystalline or amorphous depending upon the type of laser pulse used and the thermal conduction path between the medium and an approximately room temperature heat sink. Laser pulses with a sharp trailing edge would lead to rapid cooling and an amorphous state. Whereas, laser pulses that fall off sufficiently slowly allow the materials time to crystallize. As mentioned, the thickness of the magnetic material is approximately 10 to 1,000 nm thick, wherein this range of thickness is chosen for performance enhancement and design convenience as described above. Moreover, the permeability of these regions would not be modified by the application of a magnetic field. This is a first example of rewritable magnetic medium that cannot be erased by the application of a magnetic field.

A further very important aspect of the invention is that a technology based on storing information stored in the form of very small high and low magnetic permeability regions is not affected by the superparamagnetic limit. Even if the regions are so small that they are superparamagnetic, they still will interact with magnetic flux lines. The small superparamagnetic regions with an intrinsic high magnetic permeability will still tend to attract magnetic flux lines. Thus, high density recording of information encoded in small regions of high and low magnetic permeability rather than the magnetization of those regions will be limited by the ability of the reader to extract information and will not be limited by the superparamagnetic limit.

Furthermore, methods of manufacturing data storage magnetic media are provided, comprising applying a magnetic material to a substrate, altering magnetic permeable qualities of selective regions of the magnetic material by heating the selective regions with a laser pulse, and cooling the magnetic material. The laser pulse heats the selective regions that will create areas with either high or low magnetic permeability depending upon the cooling rate. The pulse turn off time will determine whether the regions will crystallize and thus have a low permeability upon cooling. The heated areas of higher (lower) permeability are dimensioned and configured to be approximately 1 to 20 microns in size. Smaller areas such as these are preferable because they lead to a higher density of recording. Additionally, the media (in all embodiments) may be covered with a protective insulator layer such as aluminum oxide.

Because the invention is able to store bits of information by purposely changing the magnetic permeability of a material in a controlled fashion such that some areas possess high magnetic permeability and other areas have low magnetic permeability, the invention is able to achieve several advantages over conventional magnetic storage devices and methods. For example, an advantage of the invention is that the storage of data will not be susceptible to being accidentally erased or altered by the presence of a magnetic field. This is possible because, according to the invention, the data is stored by an intrinsic property of the material in localized areas, wherein the intrinsic property is the ease with which it can be magnetized. This intrinsic property of the magnetic materials considered here, the magnetic permeability, is not affected by magnetic fields.

Moreover, the invention is capable of being utilized in several different applications. For example, the invention may be used in military dog tags for use in extreme environments, non-magnetic field erasable identification cards, credit cards, debit cards, mass transportation fare card information stripes, highly sensitive and secured identification cards, and magnetic storage disks in computers. All of these uses are advantageous because they are immune to the effects of applying a magnetic field to the storage media. Moreover, because it is possible to destroy the information on credit cards or mass transportation fare cards by exposing them to permanent magnets such as those used for supporting items or holding doors closed, the invention is particularly useful in these applications. Furthermore, because the invention eliminates accidental erasure of stored data, it also adds a level of security to information written in the stored media.

### BRIEF DESCRIPTION OF THE DRAWINGS

The invention will be better understood from the following detailed description of the preferred embodiments of the invention with reference to the drawings, in which:

FIG. 1 is a cross-sectional schematic diagram illustrating an intermediate step in the manufacturing process of a magnetic storage media device according to the invention;

FIG. 2 is a cross-sectional schematic diagram illustrating an intermediate step in the manufacturing process of a magnetic storage media device according to the invention;

FIG. 3 is a cross-sectional schematic diagram illustrating an intermediate step in the manufacturing process of a magnetic storage media device according to the invention;

FIG. 4 is a cross-sectional schematic diagram illustrating an intermediate step in the manufacturing process of a magnetic storage media device according to the invention;

FIG. 5 is a cross-sectional schematic diagram illustrating an intermediate step in the manufacturing process of a magnetic storage media device according to the invention;

FIG. 6 is a cross-sectional schematic diagram illustrating an intermediate step in the manufacturing process of a magnetic storage media device according to the invention;

FIG. 7 is a cross-sectional schematic diagram illustrating an intermediate step in the manufacturing process of a magnetic storage media device according to the invention;

FIG. 8 is a cross-sectional schematic diagram illustrating an intermediate step in the manufacturing process of a magnetic storage media device according to the invention;

FIG. 9 is a cross-sectional schematic diagram illustrating an intermediate step in the manufacturing process of a magnetic storage media device according to the invention;

FIG. 10 is a cross-sectional schematic diagram illustrating an intermediate step in the manufacturing process of a magnetic storage media device according to the invention;

FIG. 11 is a cross-sectional schematic diagram illustrating an intermediate step in the manufacturing process of a magnetic storage media device according to the invention;

FIG. 12 is a cross-sectional schematic diagram illustrating an intermediate step in the manufacturing process of a magnetic storage media device according to the invention; and

FIG. 13 is a cross-sectional schematic diagram illustrating another step in the manufacturing process of a magnetic storage media;

FIG. 14 is a cross-sectional schematic diagram illustrating a final step in the manufacturing process of a magnetic storage media.

FIG. 15 is a flow diagram illustrating a preferred method of the invention.

FIG. 16 is a flow diagram illustrating another preferred method of the invention.

FIG. 17 is a flow diagram illustrating still another preferred method of the invention.

### DETAILED DESCRIPTION OF PREFERRED EMBODIMENTS OF THE INVENTION

As previously mentioned, there is a need for a magnetic storage media device capable of withstanding the harmful effects of applied magnetic fields as well as a novel method of manufacturing a magnetic storage media device. Referring now to the drawings, and more particularly to FIGS. 1 through 17, there are shown preferred embodiments of the invention.

The invention provides for a magnetic storage medium that can be written once and read many times or, alternatively, can be written many times and read many times. The magnetic information medium comprises bits that are defined by local regions of about one tenth of a micron to several microns in size that differ from one another by either having a high magnetic permeability or having a low magnetic permeability. Magnetic permeability is a measure of how easily a material can be magnetized. Magnetic permeabilities for soft magnetic materials (materials with large values for their permeability) vary from several thousand for permalloy and amorphous Fe alloys to near to 1×10⁵ for Co-based amorphous alloys and Finemet®, available from Hitachi Metals, Ltd. Corporation, Tokyo, Japan. Finemet® is an ultrafine grained alloy of Fe, Si, B, Cu, and Nb. The bits are written depositing high permeability magnetic material or using a laser pulse to create the various regions of low or high permeability, and the bits are read with the use of a device that scans and determines variations in local permeability of a material, such as by a probe as described in U.S. Pat. No. 6,762,954, and entitled “Local Probe of Magnetic Properties,” the complete disclosure of which is herein incorporated by reference.

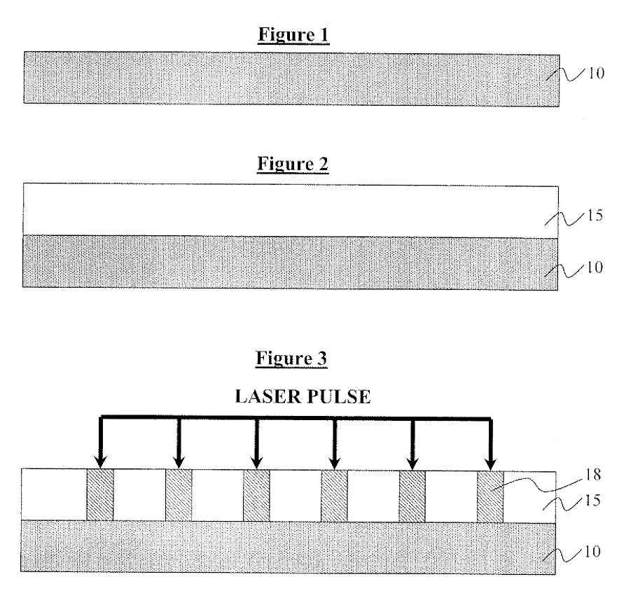

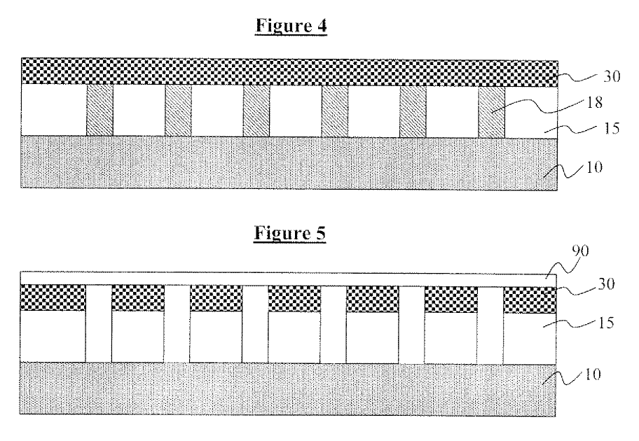

A first embodiment of the invention made using standard lithography is illustrated in FIGS. 1 through 5. This embodiment is for a read only media. In this embodiment direct write patterning is performed in areas that are to be covered with a highly permeable material. The direct write patterning can be performed several ways. As illustrated in FIG. 1, the process of manufacturing a magnetic storage media device begins with a substrate 10. The substrate 10 may comprise silicon, glass, quartz, or other materials known in the art that will not modify the magnetic media properties. A first manner of directly writing high and low magnetic permeable materials on the substrate 10 is to use a photoresist 15, wherein the substrate 10 is spin coated with the photoresist 15, as shown in FIG. 2. Then, a laser beam, or other light source, is used to define patterns 18 in the photoresist 15, as illustrated in FIG. 3. The exposure of the photoresist to light makes it soluble. Next, as shown in FIG. 4, a highly permeable material 30 such as permalloy is deposited over the photoresist 15 and the patterned regions 18. Each of the highly permeable regions may have a width 0.1 to 20 microns in their smallest dimension. The low permeable regions may have the same width. Smaller dimensions such as these are preferable because they lead to a higher density of recording. FIG. 5 illustrates the read only media after portions of the photoresist 15 and unwanted magnetic material 30 are removed by using a solvent to “lift off” the exposed regions of the photoresist 18 and the magnetic material on top of the exposed regions. Another manner of directly writing highly permeable materials is to deposit the material using an ink jet that contains highly permeable magnetic particles. Also, a protective layer 90 may be deposited over the highly permeable material 30 to provide additional protection to the underlying media. The protecting coating could be deposited by a variety of means that include solidifying a liquid, spraying, evaporation or sputtering. For example, an aluminum oxide coating can be applied by a sputtering technique. It should be understood that coating 90 is applicable to all other embodiments described herein. Both of these methods yield data density suitable for credit cards, debit cards, ID cards and military dog tags.

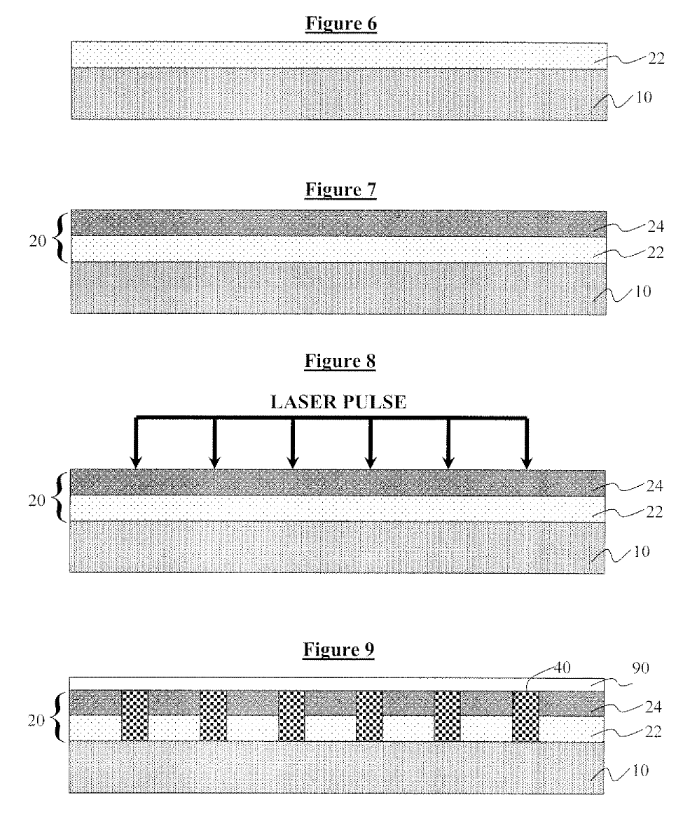

A second embodiment of the invention is illustrated in FIGS. 6 through 9. This embodiment is primarily a read only media but it could also be used for making devices such as fare cards where information is updated at each use. As shown in FIG. 6, a layer of magnetic material 22 (magnetic media) is deposited over a substrate 10. A layer of nonmagnetic material 24 is deposited over the magnetic material 22, which is illustrated in FIG. 7. Layers 22, 24, respectively together make up a bilayer 20. Preferably, the layer 22 comprises metallic glass, nickel, or permalloy, while the layer 24 comprises copper or some other material that when combined with layer 22 results in a mixed material or alloy having a low magnetic permeability. Preferably, the bilayer 20 has a thickness in the range of approximately 10 to 1,000 nm. Within the preferred range of thickness of the magnetic material, the smaller thickness (10 nm) should provide a significant change in the magnetic flux path for the magnetic reader (read head) when the magnetic reader passes over the magnetic media. In general, thicker films work better than thin films in changing the magnetic flux path. Films much thicker than the larger thickness (1,000 nm) would inherently be less conventional and more costly, and thus would not be preferable to use unless other advantages could be achieved to offset the higher cost factor.

Further with regard to FIGS. 6-9, the magnetic material 22 can be either in a crystalline state, as it would be if the magnetic material is permalloy, or an amorphous state if the magnetic material is metallic glass. In either case, the bilayer layer 20 is highly permeable. Thereafter, as shown in FIG. 8, a heat source, such as that provided by a laser pulse, is used to alter the permeability of the magnetic material 22 in bilayer 20 in specified regions. As shown in FIG. 9, when areas of the media 20 are exposed to heat, the magnetic layer 22 and the nonmagnetic layer 24 mix together resulting in a non-magnetic mixture 40 that has a low magnetic permeability. This change is non-reversible. Thus, the permeability of region 40 would not be modified by the application (exposure) of a magnetic field. Therefore, stored data in region 22 and 40 would not be altered or deleted by the application of a magnetic field. Furthermore, the areas that are not exposed to the laser pulse still posses their original magnetic permeability. Additionally, a protective layer such as aluminum oxide 90 may be deposited over regions 22 and 40 to provide additional protection to the underlying media.

Essentially, if regions 40 are sufficiently heated by the laser pulse, the magnetic material 22 and nonmagnetic material 24 in those regions 40 (such as copper and nickel) diffuse into one another, thereby resulting in a much lower permeability, about 1. Thus, selected regions can be obtained having high and low magnetic permeability. As with the first embodiment, the low permeable regions 40 and high permeability regions 22 have a minimum dimension as small as 0.1 to 20 microns. Again, smaller dimensions such as these are preferable because they lead to a higher density of recording. Instead of using a bilayer of highly permeable material and a nonmagnetic material, a multilayer geometry may also be used. This alternative has the advantages that the in-plane magnetic permeability can be larger and the atoms do not have to diffuse nearly as far when irradiated by a laser to reduce the magnetic permeability. Thus, lower power lasers can be used to perform the writing operation.

The invention could be implemented several ways. For example, one could purchase cards, such as mass transportation fare cards, that contain magnetic material as described by this embodiment and that would permit a certain amount of credit to be purchased on the card. The amount of highly permeable material would represent the amount of remaining money remaining on the card. As one made purchases a laser beam would be used to heat region 40 and, because of diffusion, reduce the number of highly permeable regions and hence the purchasing power of the card.

A third embodiment of this invention is a read/rewrite memory as illustrated in FIGS. 10 through 14. As shown in FIG. 10, the process of manufacturing a magnetic storage media device begins with a substrate 10. The substrate 10 may comprise silicon, glass, quartz, or other materials known in the art, which can withstand elevated temperatures. Next, a film of thermally conductive material 50 is deposited onto substrate 10 which is intended to act as a heat sink. Next, a film of magnetic material (magnetic media) 52 is deposited over the film of thermally conductive material 50. The film 52 may comprise a single layer of Metglas, or other similar ferromagnetic materials that undergoes a phase transition between two phases, one with a high magnetic permeability and one with a low magnetic permeability, and is approximately 10 to 1,000 nm thick. The film 52 may be deposited so as to be amorphous and, hence, highly permeable or it may be deposited so as to be crystalline and, hence, less permeable. As previously mentioned, this range of thickness of the film 50 includes a smaller thickness (10 nm) to provide a significant change in the magnetic flux path for the magnetic reader (read head) when the magnetic reader passes over the magnetic media. In general, thicker films work better than thinner films. The maximum thickness (1,000 mm) is chosen to provide ease and convenience during fabrication. Films much thicker than the maximum thickness (1,000 nm) would inherently be less conventional and more costly, and thus would not be preferable to use. There are large classes of such materials, including Fe₈₃B₁₇, that have two solid phases with very different magnetic permeabilities. Moreover, the crystalline temperatures of such materials are not too high. For example, Fe₈₃B₁₇ crystallizes at 625° K.

Alternatively, instead of using a single ferromagnetic layer, one could instead use a two-phase mixture of metglass nanoparticles embedded in a heat-drawing material having a melting temperature greater than the melting temperature of the ferromagnetic nanoparticles. The particle size can vary from 1 nanometer to 100 nanometers. Preferably, the heat-drawing material has a high melting temperature, and may include such materials as boron nitride. The volume-filling fraction of nanoparticles preferably varies from 10% to 70%. It is preferable that the nanoparticles should not mix, alloy, or form compounds with the matrix when the laser pulse melts them. Thus, boron nitride is a good choice for the matrix because, besides having a high melting temperature, it is also chemically very stable. The advantage of using nanoparticles is that the ratio of surface atoms to interior atoms is high. Because of this, they are easier to cool rapidly and it will be easier to quench in the amorphous phase. This mixture can be made first by co-sputtering the metglass and the matrix, followed by heating the resulting film to cause phase separation as described in Edelstein et al., Journal of Applied Physics, vol. 61, no. 8, ser. 2A (15 Apr. 1987), the complete disclosure of which is herein incorporated by reference.

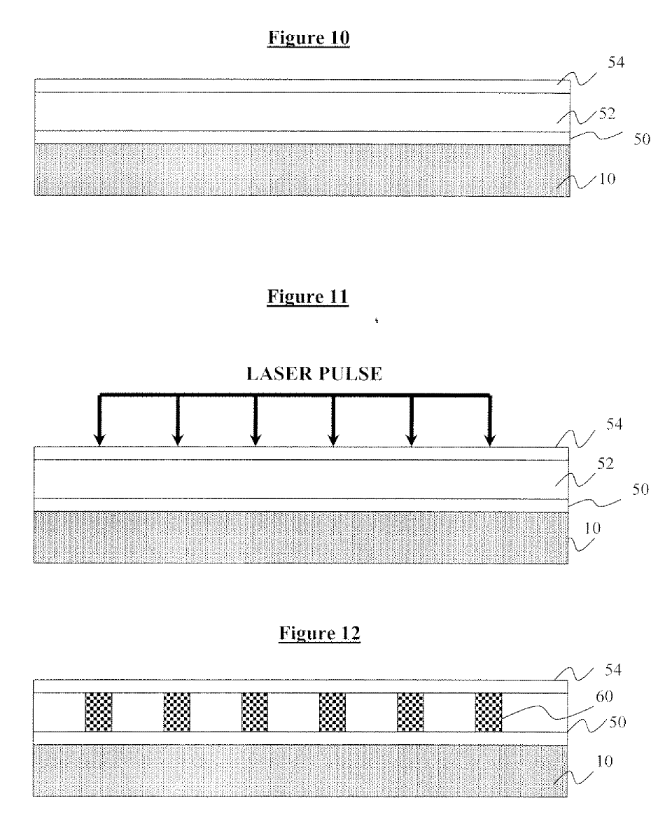

In the process illustrated in FIGS. 11 and 12, a laser pulse is used to alter the permeability of the magnetic material 52 in specified regions. Suppose magnetic material 52 is originally amorphous. Thus, when the specified regions are heated sufficiently by the laser and cooled slowly, the resulting specified regions 60 become crystallized and are much less permeable than the amorphous regions of the magnetic material 52, as illustrated in FIG. 12. The slow cooling may be accomplished by using a laser pulse for the heating that turns off slowly. Alternatively, if magnetic material 52 was originally crystalline, then selected regions could be converted to amorphous state by applying laser pulses followed by sufficiently rapid cooling. The rapid cooling may be accomplished by using a laser pulse for the heating that turns off rapidly and using the high conductivity material 50 as a heat sink. The low permeable regions 60 and high permeability regions have a minimum dimension as small as 0.1 to 20 microns. As previously mentioned, smaller dimensions such as these are preferable because they lead to a higher density of recording. Thus, one can write regions that will have either high or low magnetic permeability. An example of a laser that could be used in practicing the invention is available from Coherent Inc., CA, USA, and others. Preferably, the laser used in conjunction with the invention has a sufficient power in a pulse mode to melt the regions containing one bit of information. Moreover, the laser is preferably able to be programmed to either turn off this pulse sufficiently slowly such that the film 52 may crystallize, or to turn off quickly enough such that the film 52 is quenched in its amorphous state. As with the earlier embodiments, the low permeable regions 60 have a minimum dimension as small as 1 to 20 microns, which result in a higher density of recording. Furthermore, a protective insulator layer such as aluminum oxide 54 may be deposited over regions 50 and 60 to provide additional protection to the underlying media.

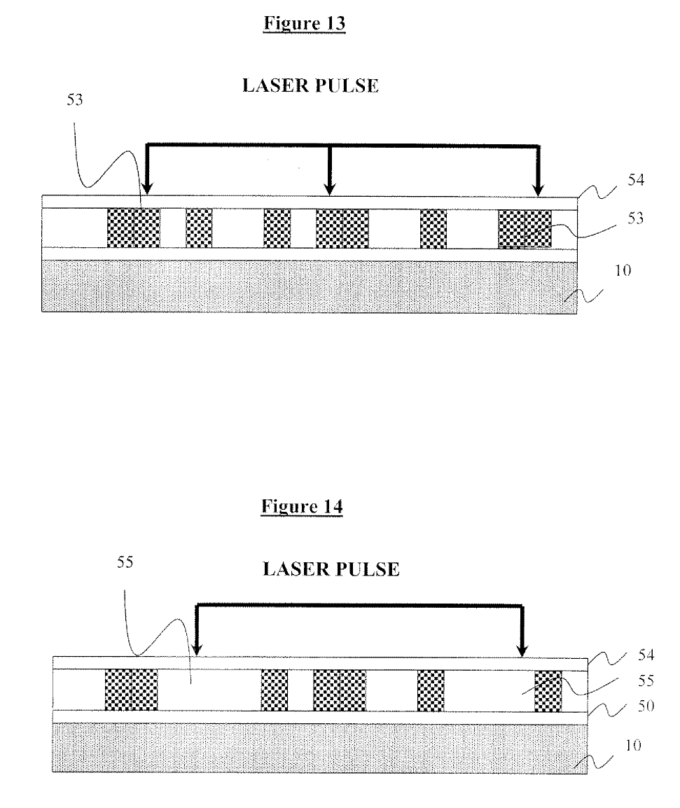

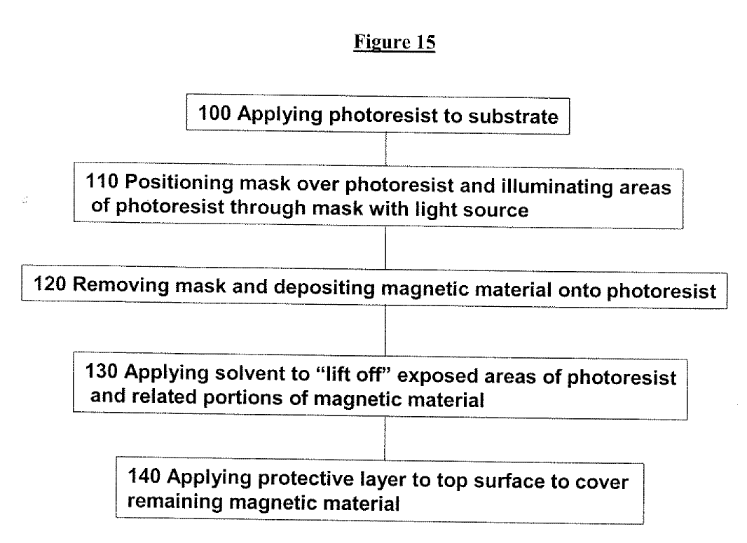

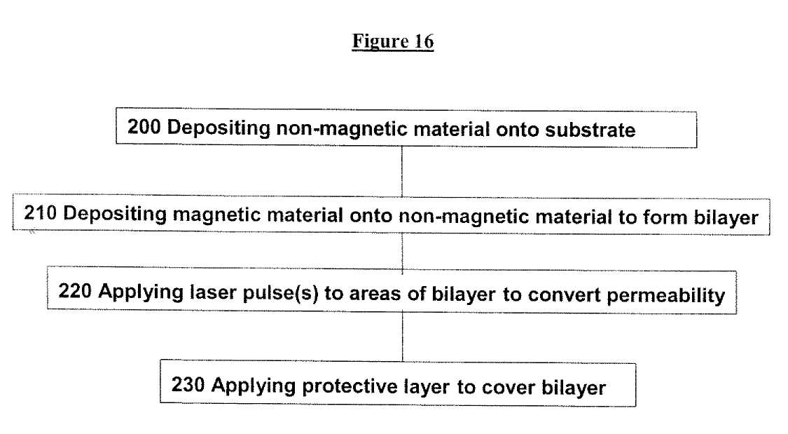

FIGS. 13 and 14 illustrate the rewrite process that may be applied to further alter the permeability of the magnetic material 52. FIG. 13 illustrates rewriting selected crystalline state regions into amorphous state regions 53 by applying appropriate heat pulses, such as laser pulses, followed by rapid cooling of the pulsed areas. FIG. 14 illustrates rewriting selected amorphous state regions into crystalline state regions 55 by applying appropriate heat pulses followed by slow cooling of the pulsed area.

In FIG. 15, a flowchart illustrating a preferred method of making the data storage magnetic media of FIGS. 1 through 5 is shown, which includes the steps of: 100 applying a photoresist 15 to substrate 10; 10 positioning a mask over the photoresist 15 and illuminating selected areas of the photoresist 15 through the mask with a light source; 120 removing the mask and depositing a magnetic material 30 onto the photoresist 15; 130 applying a solvent to “lift off” the exposed areas of photoresist 15 and the portions of magnetic material 30 thereon; and 140 applying a protective layer 90, such as aluminum oxide, to the top surface to cover the remaining portions of magnetic material 30.

In FIG. 16, a flowchart illustrating a preferred method of making the data storage magnetic media of FIGS. 6 through 9 is shown, which includes the steps of: 200 depositing non-magnetic material 22 onto the substrate 10; 210 depositing magnetic material 24 onto non-magnetic material 22 to form bilayer 20; 220 applying laser pulses to areas of bilayer 20 to convert those areas from a higher permeability phase to a lower permeability phase (areas 40 shown in FIG. 9); and 230 applying a protective layer 90, such as an aluminum oxide, to the top surface to cover the bilayer 20 including the lower permeability phase areas 40.

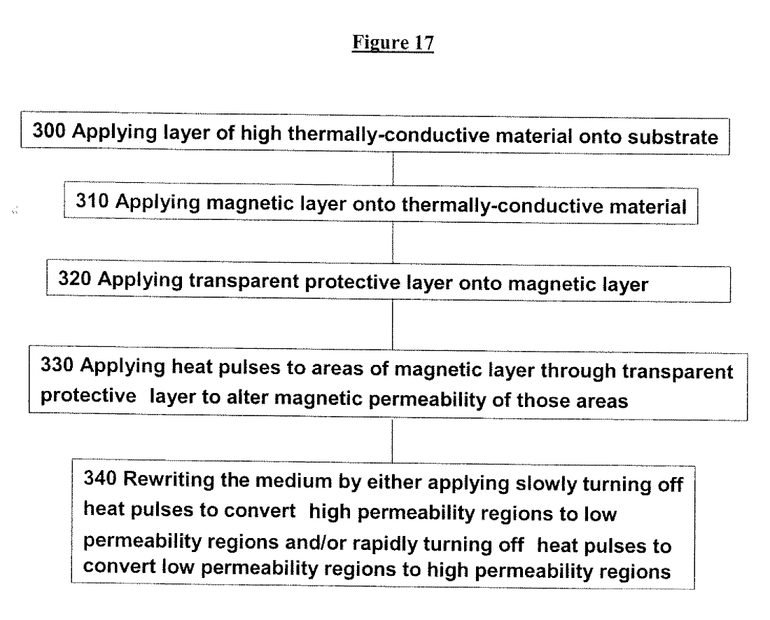

In FIG. 17, a flowchart illustrates a preferred method of making and recording onto the re-writable data storage magnetic media of FIGS. 10 through 14 which includes the steps of: 300 applying a layer of highly thermally-conductive material 50 that will act as a heat sink onto substrate 10; 310 applying a magnetic layer 52 on top of the thermally-conductive material 50; 320 applying a transparent protective layer 54 on top of the magnetic layer 52; and 330 applying a heat pulse that turns off slowly in time, such as a laser pulse, to areas of magnetic layer 52 through the transparent protective layer 54 to alter the magnetic permeability of those areas from one phase (for example, from a high permeability phase such as displayed by a metallic glass with the appropriate composition, for example a Metglas) to another phase (for example, to a low magnetic permeability phase such as displayed by a crystallized form of the metallic glass) and thereby write data for storage. Alternatively, for the magnetic layer one could have originally deposited a low permeability magnetic material, such as the crystallized form of the metallic glass, and then applied to selected areas a heat pulse that stops sufficiently abruptly such that the regions cool quickly enough to be amorphous thereby converting the crystalline regions to high magnetic permeability metallic glass. In either case, one can then 340 rewrite the medium by either applying slowly turning off head pulses to convert high permeability regions to low permeability regions and/or rapidly turning off heat pulses to convert low permeability regions to high permeability regions. The necessary quench rates to maintain the amorphous state for ferromagnetic materials with high magnetic permeabilities is in the order of 1×10⁶ Kelvin/sec. The magnetic film 52 may comprise a multilayered structure of 22 and 24, small particles of a material that has two phases embedded in a chemically stable phase with a high melting temperature, or the film 52 may be a magnetic material that may comprise any of permalloy, metallic glass, nickel, iron, cobalt, and glass formers such as boron and silicon, and any combination thereof.

Because the invention is able to store bits of information by purposely changing the magnetic permeability of a material in a controlled fashion such that some areas possess high magnetic permeability and other areas have low magnetic permeability, the invention is able to achieve several advantages over conventional devices and methods. For example, an advantage of the invention is that the storage of data will not be susceptible to being accidentally erased or altered by the presence of a magnetic field. This is possible because, according to the invention, the data is stored by an intrinsic property of the material in localized areas, wherein the intrinsic property is the ease with which it can be magnetized; i.e., the magnetic permeability.

Moreover, the invention is capable of being utilized in several different applications. For example, the invention may be used in military dog tags for use in extreme environments, non-magnetic field erasable identification cards, credit card, debit card, and mass transportation fare card information stripes, highly sensitive and secured identification cards, and magnetic storage disks in computers. All of these uses are advantageous because they are immune to the effects of applying a magnetic field to the storage media. Moreover, because it is possible to destroy the information on credit cards or mass transportation fare cards by exposing them to permanent magnets such as those used for supporting items or holding doors closed, the invention is particularly useful in these applications. Furthermore, because the invention eliminates accidental erasure of stored data, it also adds a level of security to information written in the stored media.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

What is claimed is:

1. A magnetic recording medium comprising:
a substrate;
a magnetically permeable material formed on said substrate and configured into discrete regions of low magnetic permeability and discrete regions of high magnetic permeability having magnetic permeability values so that the magnetic permeability ratio between the regions of high magnetic permeability and regions of low magnetic permeability is at least about 1000 to 1.

2. The magnetic recording medium of claim 1 wherein said magnetically permeable material comprises superimposed layers of magnetic material and nonmagnetic material wherein said discrete regions of low magnetic permeability have been formed by intermixing of said magnetic material and said nonmagnetic material.

3. The magnetic recording medium of claim 2 wherein said magnetic material comprises any of permalloy, metallic glass, nickel and any combination thereof.

4. The magnetic recording medium of claim 2 wherein said nonmagnetic material comprises copper, air, vacuum or any nonmagnetic material.

5. The magnetic recording medium of claim 2 wherein said magnetic material is in a crystalline state.

6. The magnetic recording medium of claim 2 wherein said magnetic material is in an amorphous state.

7. The magnetic recording medium of claim 1 further comprising a protective layer overlaying said continuous material.

8. The magnetic recording medium of claim 7 wherein said protective layer comprises aluminum oxide.

9. The magnetic recording medium of claim 2 wherein said magnetic material is about 10 to 1,000 mm thick.

10. The magnetic recording medium of claim 1 wherein said magnetically permeable alterable material comprises superimposed layers of magnetic material and nonmagnetic material wherein said discrete regions of low magnetic permeability have been formed by diffusion occurring between said magnetic material and said nonmagnetic material.

11. The magnetic recording medium of claim 10 wherein said discrete regions of low magnetic permeability have been formed by the application of laser pulses.

12. A method for applying and subsequent reading of data onto a magnetic media comprising:
heating selected regions of a magnetically permeable and alterable material to alter the magnetic permeability of said selected regions creating a magnetic permeability ratio between regions of at least about 1000 to 1; and
cooling said magnetically permeable material.

13. The method of claim 12 further comprising:
heating selected regions of the magnetically permeable and alterable material a subsequent time with rapidly turning off heat pulses to alter the selected regions from having low permeability into regions having high permeability while maintaining the permeability ratio between high permeability and low permeability regions of at least about 1000 to 1.

14. The method of claim 12 further comprising:
heating previously unselected regions of the magnetic material with slowly turning off heat pulses to alter the previously unselected regions from high permeability regions into regions having low permeability while maintaining the permeability ratio between high permeability and low permeability regions of at least about 1000 to 1.

15. A method of manufacturing data storage media comprising:
applying a magnetic material to a substrate;
altering magnetic permeability qualities of selected regions of said magnetic material by heating said selected regions to create areas of lower magnetic permeability compared to unheated regions so that the difference in magnetic permeability is a factor of about 1000 or more;
and cooling said magnetic material.

16. The method of claim 15, wherein said magnetic material comprises a multilayered structure.

17. The method of claim 16, wherein said multilayered structure comprises a two-phase mixture of ferromagnetic nanoparticles embedded in a heat-drawing material having a melting temperature greater than the melting temperature of said ferromagnetic particles.

18. The method of claim 15, wherein said magnetic material comprises any of permalloy, metallic glass, copper, nickel, iron, cobalt, boron, silicon and any combination thereof.

19. The method of claim 15, wherein said magnetic material is about 10 to 1,000 nm thick.

20. The method of claim 15, wherein said regions having lower magnetic permeability than other regions are crystalline.

21. The method of claim 15, wherein said regions having lower magnetic permeability than other regions are dimensioned to be about 0.1 to 20 microns in size.

22. The method of claim 15, further comprising:
applying an insulator on said magnetic material.
